(19) United States
(12) Patent Application Publication
(10) Pub. No.: US 2003/0192055 A1
(43) Pub. Date: Oct. 9, 2003

(54) Access point for local area radio communication and radio communication system using the same

(76) Inventors: Fumihiko Aoki, Kashiba-shi (JP); Kazuya Oyama, Ikoma-shi (JP)

Correspondence Address: NIXON & VANDERHYE, PC, 1100 N GLEBE ROAD, 8TH FLOOR, ARLINGTON, VA, 22201-4714, US

(21) Appl. No.: 10/375,002

(22) Filed: Feb. 28, 2003

(30) Foreign Application Priority Data
Apr. 3, 2002 (JP) 2002-101651 (P)

(51) Int. Cl. H04N 7/173; H04N 7/16

(52) U.S. Cl. 725/109; 725/62; 725/119

(57) ABSTRACT

An access point includes a gateway enabling an internet connection, a settop box selecting and outputting a video signal and an audio signal from a plurality of tuners respectively receiving broadcastings corresponding to a request signal, and an AV/LAN radio transmission module having an AV communication module for transmitting and receiving a video signal and an audio signal by wireless, a radio LAN transmission and reception module performing transmission and reception, and transmission and reception antenna, and local area radio communication and communication for a plurality of AV signal distributions are performed in frequency bands that are not overlapping one another. Therefore, a radio LAN such as the internet as well as broadcasting contents distribution can be provided to a mobile information terminal device.

### BACKGROUND OF THE INVENTION

1. Field of the Invention

The present invention relates to an access point and a radio communication system and, more specifically, to local area radio communication between an access point and a plurality of radio information terminals.

2. Description of the Background Art

Local area communication between a plurality of mobile information terminal devices such as notebook-type personal computers (hereafter referred to as notebook computers) or PDAs (Personal Digital Assistants) and an access point is performed in a system as shown in FIG. 15 or 16.

In an example shown in FIG. 15, a gateway 32 and an AP-side radio LAN (Local Area Network) transmission module 38 are included in an access point 11, and local area communication via a radio LAN is performed between access point 11 and notebook computers 12, 13 and a PDA 14.

Gateway 32 in access point 11 has a cable modem 25, an ONU (Optical Network Unit) 26 and an xDSL (Digital Subscriber Line) modem 27. Cable modem 25 is connected to a CATV (Community Antenna Television) circuit 27, while ONU 26 is connected to an FTTH (Fiber To The Home) circuit 29, and xDSL modem 27 is connected to an ads circuit 30. AP-side radio LAN transmission module 38 includes a radio LAN transmission and reception module 4 and a transmission and reception antenna 7. Transmission and reception antenna 7 is provided to perform a radio LAN communication with notebook computers 12, 13 or PDA 14, and each of notebook computers 12, 13 and PDA 14 includes a transmission and reception antenna and a radio LAN transmission and reception module.

In this example, a radio LAN is configured between, for example, a transmission and reception antenna of notebook computer 12 and transmission and reception antenna 7 of AP-side radio LAN transmission module 38, and communication with one of CATV circuit 27, FTTH circuit 29 and ads circuit 30 is performed by radio LAN transmission and reception module 4 via one of cable modem 25, ONU 26 and xDSL modem 27.

In a system shown in FIG. 16, on the other hand, an analog ground wave reception antenna 40 is connected to a ground wave tuner 15, and ground wave broadcasting is received by ground wave tuner 15 and the received output is provided to an AV radio transmission module 41. AV radio transmission module 41 has an AV transmission module 1 and a transmission antenna 5. Broadcasting contents of video and audio are distributed from AV radio transmission module 41 to an AV radio reception module 42. AV radio reception module 42 includes a transmission and reception antenna 8 and an AV reception module, and outputs video and audio signals to a TV monitor 43.

As described above, a conventional system was the internet or an intranet as shown in FIG. 15 which only communicated information data, or a system as shown in FIG. 16 which only transmitted broadcasting contents of video and audio by wireless. There was no system which can provide both a radio LAN such as the internet or an intranet which communicates information data and a distribution service of broadcasting contents of video and audio in a combination of one access point and a plurality of radio information terminal devices.

Some users, however, may desire to use the radio LAN such as the internet with their mobile information terminal devices such as notebook computers or PDAs in a cafe, an airport or the like, while other users may desire to receive the distribution of broadcasting contents with the mobile information terminal devices.

### SUMMARY OF THE INVENTION

Therefore, a main object of the present invention is to provide an access point and a radio communication system of a local area which enable radio LAN communication such as internet communication with a mobile information terminal device as well as reception of broadcasting contents distribution with the mobile information terminal device.

Another object of the present invention is to provide broadcasting contents distribution of a system to as many mobile information terminal devices as possible by wireless within a limited bandwidth with due consideration for clearness of video and audio.

An access point according to the present invention is provided with a gateway unit enabling an internet connection in a plurality of different circuits, a settop box unit having a tuner to receive broadcasting from each of a plurality of different media and a selector selecting and outputting a video signal and an audio signal from the tuner corresponding to a request signal, and an AV/LAN radio transmission module unit having a video and audio communication module to transmit a video signal and an audio signal from the settop box unit by wireless and receive a request signal for changing a received broadcasting channel and broadcasting media, a transmission and reception module connected to pairs of communication antennas and the gateway unit and performing transmission and reception for local area radio communication, and a pair of transmission and reception antennas.

With this, as the local area radio communication and communication for a plurality of AV signal distributions and reception of the request signal for changing a received broadcasting channel and broadcasting media are respectively performed in frequency bands that are not overlapping one another, a local area radio communication system can be provided which enables both of radio LAN communication such as the internet communication with a mobile information terminal such as a notebook computer or a PDA brought in a cafe, an airport or the like, and distribution of broadcasting contents to the mobile information terminal.

Furthermore, broadcasting contents distribution of the system can be provided to as many information terminals as possible by wireless within a limited bandwidth with due consideration for clearness of video and audio.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of an access point according to a first embodiment of the present invention.

FIGS. 2A-2C are block diagrams of notebook computers and a PDA configuring a local area communication system with the access point shown in FIG. 1.

FIG. 3 is a block diagram of a second embodiment of an access point.

FIG. 4 is a specific circuit diagram of a selector shown in FIG. 3.

FIG. 5 is a flow chart for describing operations of a selector and a change-over switch.

FIG. 6 is a flow chart for describing operations of a selector and a change-over switch.

FIGS. 7A and 7B are tables indicating relations between a control terminal input of a change-over switch and a selected terminal.

FIG. 8 is a flow chart for describing operations of a selector and a change-over switch.

FIG. 9 is a flow chart for describing operations of a selector and a change-over switch.

FIGS. 10A and 10B show relations between a control terminal input of a change-over switch and a selected terminal.

FIG. 11 is a block diagram of an access point according to a third embodiment of the present invention.

FIG. 12 is a block diagram of an access point according to a fourth embodiment of the present invention.

FIG. 13 is a block diagram of an access point according to a fifth embodiment of the present invention.

FIG. 14 is a block diagram of an access point according to a sixth embodiment of the present invention.

FIG. 15 is a block diagram of a conventional access point including a gateway and an AP-side radio LAN transmission module.

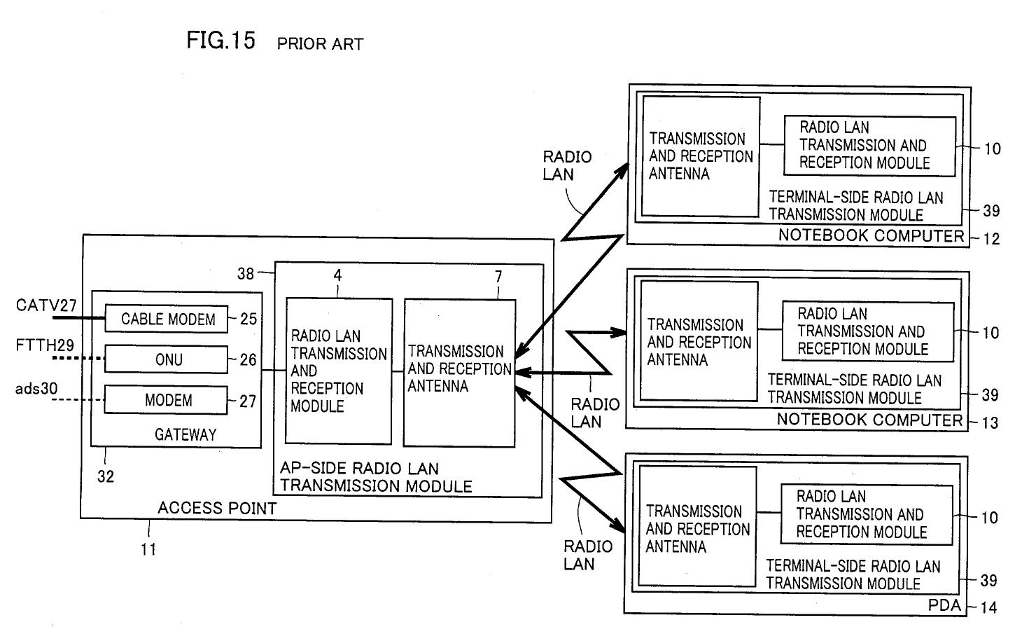

FIG. 16 is a block diagram of a conventional system transmitting only broadcasting contents of video and audio by wireless.

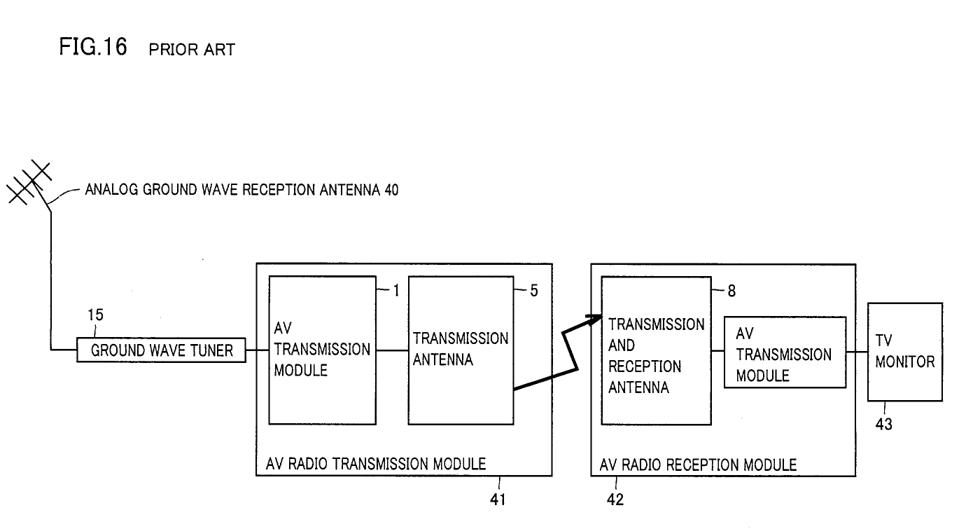

### DESCRIPTION OF THE PREFERRED EMBODIMENTS

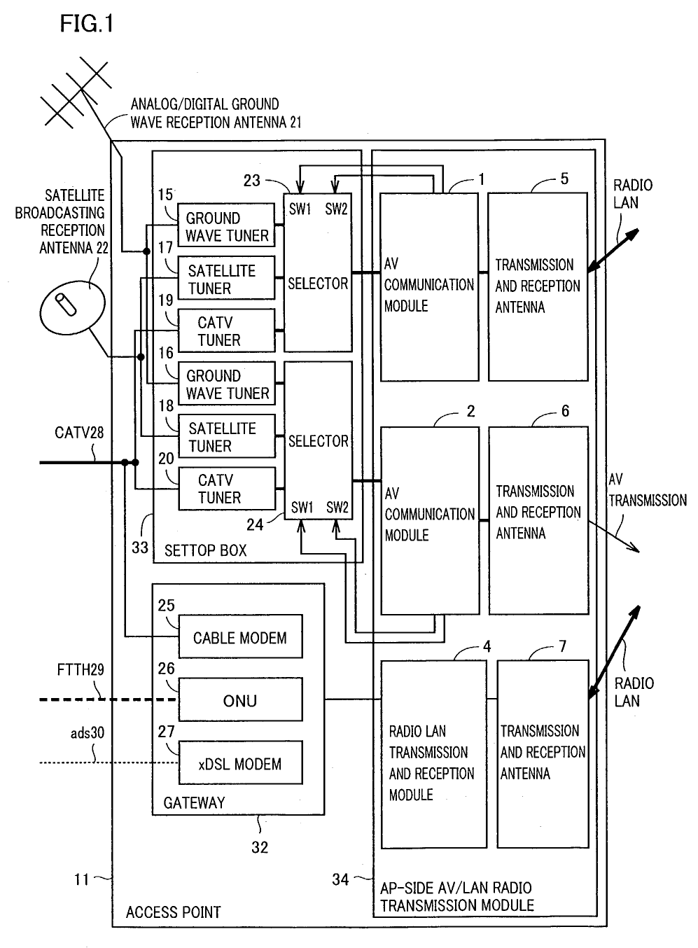

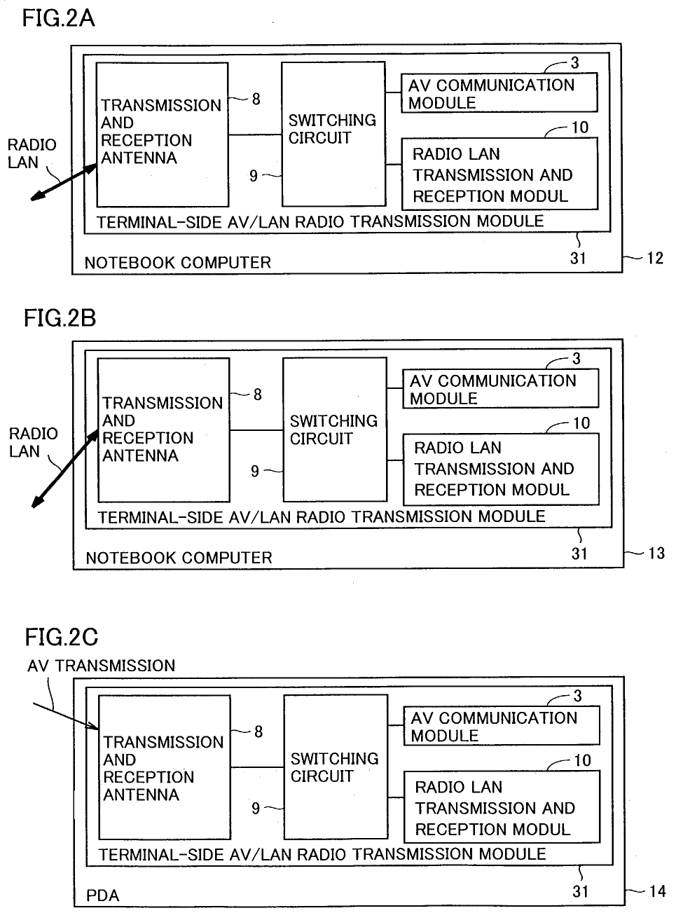

FIG. 1 is a block diagram of an access point according to a first embodiment of the present invention, and FIGS. 2A-2C are block diagrams of notebook computers and a PDA configuring a local area communication system with the access point shown in FIG. 1.

Access point 11 shown in FIG. 1 configures a local area communication system with one of notebook computers 12, 13 and PDA 14 shown in FIGS. 2A-2C via a radio LAN using a frequency band of 2.4 GHz.

In FIG. 1, access point 11 is mainly formed with three portions as described below. A first portion thereof includes gateway 32 enabling an internet connection in a plurality of different circuits, while a second portion includes a settop box 33 receiving a plurality of different broadcastings and selecting from the received plurality of broadcastings corresponding to a request signal to output an AV signal, and a third portion includes a radio LAN transmission and reception unit connected to gateway 32 and performing transmission and reception as a radio LAN of 2.4 GHz and an access point-side AV/LAN radio transmission module 34 including a plurality of AV communication units connected to settop box 33 of the second portion to transmit an AV output signal of settop box 33 by wireless of a 2.4 GHz band and receive a received broadcasting channel change signal and a broadcasting media change signal by wireless of a 2.4 GHz band.

Herein, the radio LAN transmission and reception unit of access point-side AV/LAN radio transmission module 34 includes radio LAN transmission and reception module 4 as a signal processing unit and transmission and reception antenna 7 of an antenna unit, and the plurality of AV communication units also include pairs of AV communication modules 1, 2 as signal processing units and transmission and reception antennas 5, 6 of the antenna unit.

To enable connections to multiple kinds of circuits, that is, to CATV 28, FTTH 29 and ads 30, gateway 32 includes cable modem 25 for connection to CATV 28, ONU 26 for connection to FTTH 29 of optical fiber communication, and xDSL modem 27 for connection to ads 30 (a generic name for ADSL, SDSL and VDSL). To enable reception of a plurality of different broadcasting media, settop box 33 includes analog or digital ground wave tuners 15, 16, satellite tuners 17, 18, CATV tuners 19, 20, a selector 23 to select one of outputs of ground wave tuner 15, satellite tuner 17 and CATV tuner 19, and a selector 24 to select one of outputs of ground wave tuner 16, satellite tuner 18 and CATV tuner 20. An analog/digital ground wave reception antenna 21 is connected to ground wave tuners 15, 16, while a satellite broadcasting reception antenna 22 is connected to satellite tuners 17, 18.

Though the example shown in FIG. 1 includes all of cable modem 25, ONU 26, xDSL 30, ground wave tuner 15/16, satellite tuner 17/18, and CATV tuner 19/20, the present invention is not limited to this and any of the elements may be eliminated.

Each of notebook computers 12, 13 shown in FIGS. 2A and 2B includes transmission and reception antenna 8, a switching circuit 9, an AV communication module 3, and a radio LAN transmission and reception module 10. PDA 14 includes transmission and reception antenna 8, switching circuit 9, AV communication module 3, and radio LAN transmission and reception module 10. These notebook computers 12, 13 and PDA 14 are connected to access point 11 via a radio LAN or an AV transmission line.

Operations in this embodiment will now be described. First, a user brings a radio terminal, which is any of notebook computers 12, 13 and PDA 14, in a communication area of the access point and, after starting the radio terminal, selects whether to receive AV signal distribution of broadcasting contents or to use a radio LAN by operating the radio terminal. In the radio terminal, switching circuit 9 starts one of AV communication module 3 and radio LAN transmission and reception module 10 based on this selection information.

When the radio LAN is selected, radio LAN transmission and reception module 10 is started, and radio LAN transmission and reception module 10 receives a radio terminal sense signal originated from transmission and reception antenna 7 by radio LAN transmission and reception module 4 in AV/LAN radio transmission module 34 of a side of access point 11, and sends back a radio LAN connection request signal by wireless via transmission and reception antenna 8 to start radio LAN communication.

When the AV signal distribution is selected, AV communication module 3 of the radio terminal is started, and AV communication module 3 receives a radio terminal sense signal originated from transmission and reception antenna 5 or 6 by one of a plurality of AV communication modules 1 and 2 in AV/LAN radio transmission module 34 of a side of access point 11, and sends back an AV signal distribution request signal by wireless via transmission and reception antenna 8 to start communication. When the communication is started, a tuner can first be selected.

A list of tuners is sent from AV communication module 1 or 2, and the radio terminal side sends a selection signal of the tuner to AV communication module 3 based on the received list, and AV communication module 1 or 2 controls selector 23, 24 for connection with the requested tuner and starts transmission of the AV signal to the connected radio terminal.

This distribution is continued until a change request signal for the selected tuner or a communication termination request signal is originated from the radio terminal. Change of a channel in the selected tuner is implemented by sending a channel change request signal from the radio terminal side to access point-side AV communication module 1 or 2 which is in communication, and transmitting the signal from the AV communication module receiving the signal to the connected tuner through an AV signal and channel change signal transmission path.

In FIGS. 2A-2C, a situation is shown wherein notebook computer 12 communicates with access point-side AV communication module 1 shown in FIG. 1 to receive the AV signal distribution, while notebook computer 13 communicates with access point-side radio LAN transmission and reception module 4 to perform the radio LAN communication, and PDA 14 communicates with access point-side AV communication module 2 to receive the AV signal distribution.

In this embodiment, when there are a plurality of AV access point-side AV communication modules which are not in communication with the radio terminals, radio terminal sense signals are originated from all of these AV communication modules. After the AV communication module is started, the radio terminal senses by successively switching a reception frequency bandwidth in a 2.4 GHz band and starts communication with the AV communication module originating the radio terminal sense signal which can first be received. It cannot be predicted which AV communication module is to be connected, because it also depends on a communication environment at that time.

On the contrary, priorities may previously be assigned to AV communication modules to make an AV communication module having the highest priority of unconnected AV communication modules communicate with the radio terminal. In this situation, unconnected AV communication modules first transmit radio terminal sense signals including priorities thereof. The radio terminal, on the other hand, sends back the AV signal distribution request signal to the access point-side AV communication module originating a signal including the highest priority of the received priority-added radio terminal sense signals to start communication.

By configuring the local area communication system as such, a local area radio communication system can be provided which enables radio LAN communication such as the internet communication with notebook computers 12, 13 or PDA 14 as well as reception of broadcasting contents distribution with notebook computers 12, 13 or PDA 14. In addition, broadcasting contents distribution can be provided to as many notebook computers 12, 13 or PDA 14 as possible by wireless within a limited bandwidth with due consideration for clearness of video and audio.

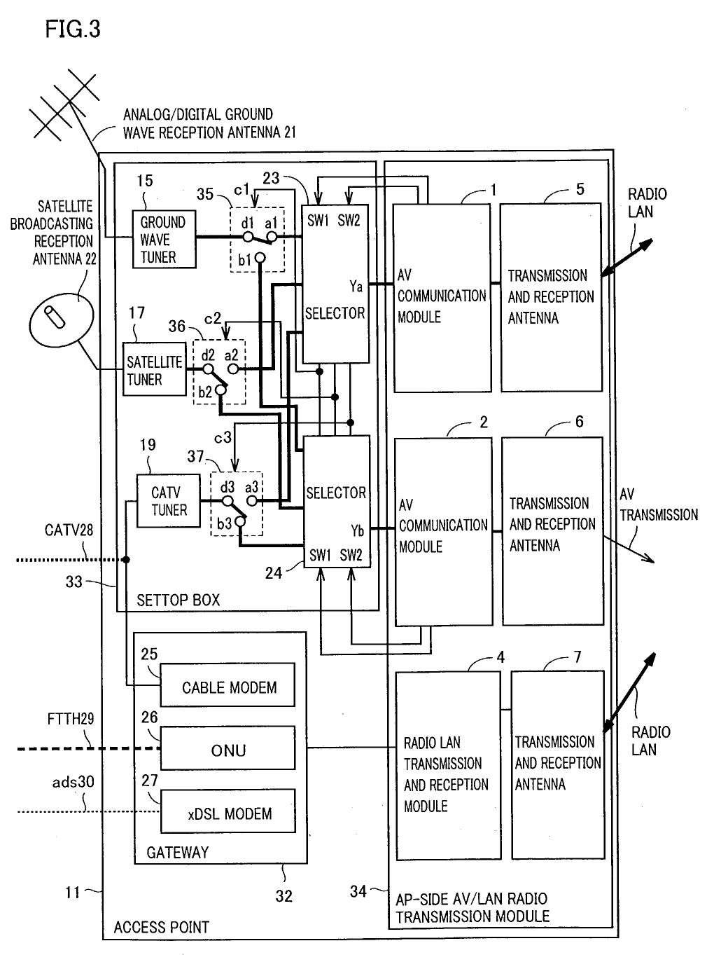

FIG. 3 is a block diagram of a second embodiment of an access point. Though the embodiment shown in FIG. 1 includes two tuners of each kind for respective AV communication modules 1, 2 in settop box 33, the embodiment shown in FIG. 3 includes only each ones of ground wave tuner 15, satellite tuner 17 and CATV tuner 19. Change-over switches 35-37 are provided to switch outputs of respective tuners 15, 17, 19 and provide to selectors 23, 24.

An AV output and channel change signal input transmission path of ground wave tuner 15 is connected to a d1 terminal of change-over switch 35. Change-over switch 35 connects the d1 terminal to an a1 terminal when a control input c1 is set to the “L” level, and connects the d1 terminal to a b1 terminal when control input c1 is set to the “H” level. The a1 terminal is connected to selector 23, while the b1 terminal is connected to selector 24. A control terminal c1 is connected to a three-state output outputting an “H”/“L” level signal of change-over switch control for both selectors 23 and 24 to form a bus line of the change-over switch control.

An output from each selector to this bus line is such that, while selector 23 is outputting a control signal of the “H” level, selector 24 sets a control signal output to a high impedance state and keeps the change-over switch control bus line at the “H” level. With this, al-side of change-over switch 35 is turned on, and an AV signal output and channel change signal transmission path of ground wave tuner 15 is input to selector 23.

While selector 24 is outputting a control signal of the “L” level, selector 23 sets a control signal output to a high impedance state and keeps the change-over switch control bus line at the “L” level. With this, b1-side of change-over switch 35 is turned on, and the AV signal output and channel change signal transmission path of ground wave tuner 15 is input to selector 24. An AV output and channel change signal input transmission path of satellite tuner 17 is connected to a d2 terminal of change-over switch 36. Change-over switch 36 connects the d2 terminal to an a2 terminal when a control input c2 is set to the “L” level, and connects the d2 terminal to a b2 terminal when control input c² is set to the “H” level. The a2 terminal is connected to selector 23 as the a1 terminal, while the b2 terminal is connected to selector 24.

Similar to control terminal cl, a control terminal c2 is also connected to a three-state output outputting an “H”/“L” level signal of change-over switch control for both selectors 23 and 24 to form a bus line of the changeover switch control. While selector 23 is outputting a control signal of the “H” level, selector 24 sets a control signal output to a high impedance state and keeps the change-over switch control bus line at the “H” level. With this, a2-side of change-over switch 36 is turned on, and an AV signal output and channel change signal transmission path of satellite tuner 17 is input to selector 23.

While selector 24 is outputting a control signal of the “L” level, selector 23 sets a control signal output to a high impedance state and keeps the change-over switch control bus line at the “L” level. With this, b2-side of change-over switch 36 is turned on, and the AV signal output and channel change signal transmission path of satellite tuner 17 is input to selector 24. Change-over switch 37 switches an AV output and channel change signal of CATV tuner 19 to connect a d3 terminal to an a3 terminal when a control input c3 connected to the d3 terminal is set to the “L” level, and connect the d3 terminal to a b3 terminal when control input c3 is set to the “H” level. The a3 terminal is connected to selector 23 as the a1/a2 terminal, while the b3 terminal is connected to selector 24 as the b1/b2 terminal. Similar to the c1/c2 terminal, a control terminal c3 is also connected to a three-state output outputting an “H”/“L” level signal of change-over switch control for both selectors 23 and 24 to form a bus line of the change-over switch control, and determines to which selector an AV signal output and channel change signal transmission path of CATV tuner 19 is to be connected corresponding to control signal outputs of selectors 23, 24.

In addition, an AV signal output and channel change signal input terminal Ya of selector 23 and an AV signal output and channel change signal input terminal Yb of selector 24 as well as SW1/SW2 terminals inputting a control signal for selecting a tuner from the AV communication module-side are connected to AV communication modules 1 and 2. When AV communication modules 1, 2 receive a tuner selection signal from a radio communication terminal, a control signal of combination of the “H”/“L” levels is sent to SW1/SW2 of a selector A/B. With this control input, one of the terminals of the change-over switches a1/a2/a3 to be connected to AV signal output and channel change signal input terminal Ya of selector 23 is determined, and one of the terminals of the change-over switches b1/b2/b3 to be connected to AV signal output and channel change signal input terminal Yb of selector 24 is determined. Concurrently with this selection of the change-over switch, each of selectors 23, 24 detects whether the other selector has already selected the selected change-over switch and is controlling the change-over switch by sending a control output from the control bus line or not, and if the change-over switch is not controlled, outputs a control signal to the control bus line and turns the switch to a side thereof.

If the control bus is already controlled by the other selector, the change-over switch remains connected to a side of the other selector controlling the control bus.

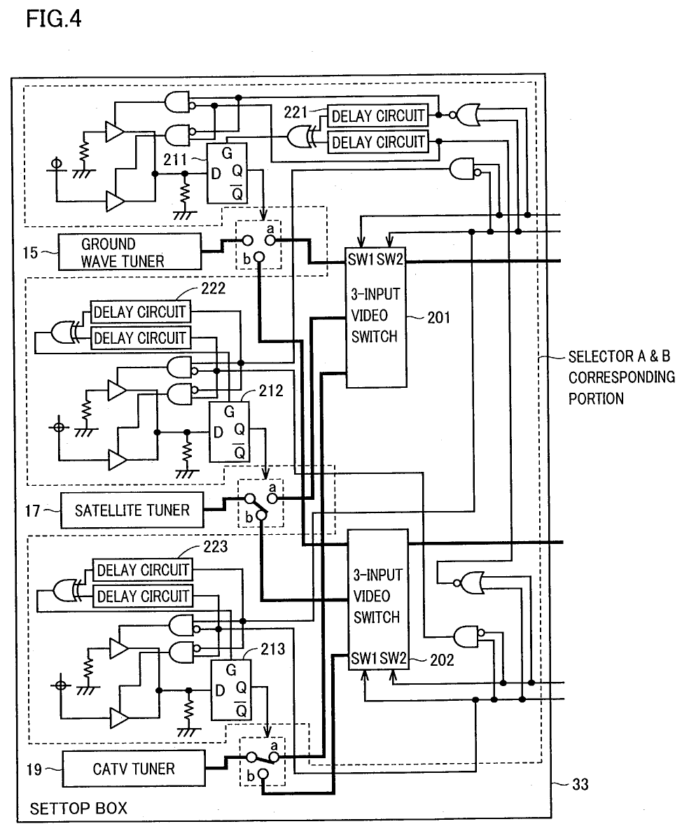

FIG. 4 is a specific circuit diagram of the selector shown in FIG. 3. In FIG. 4, the selector is formed with generalized circuits including three-input video switches 201, 202, D type latch circuits 211, 212, 213, and delay circuits 221, 222, 223 as main circuits, and also including a three-state buffer gate, an exclusive OR gate, an AND gate, an inverter gate, a pull-up resistor, and a pull-down gate.

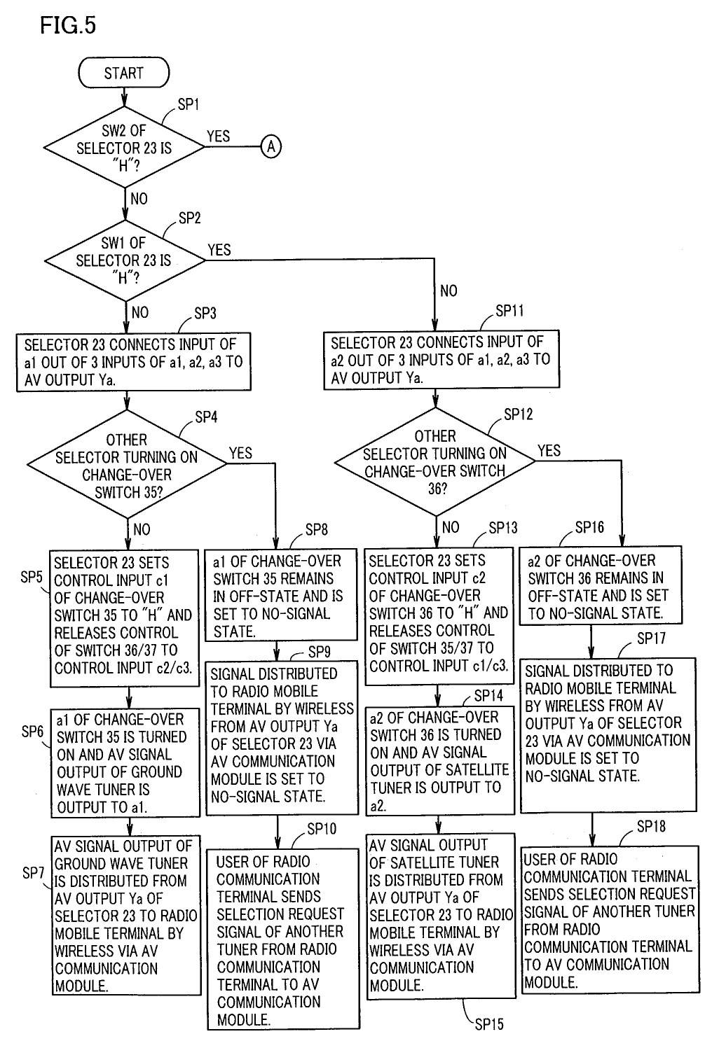

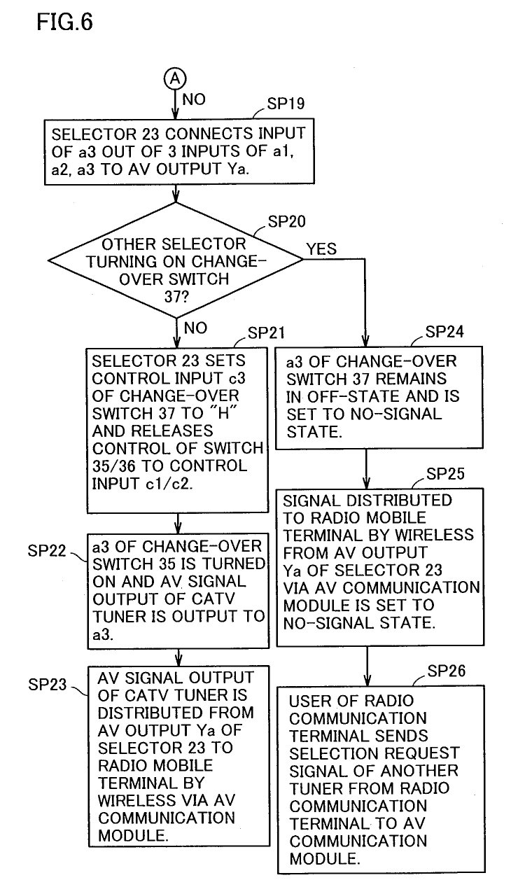

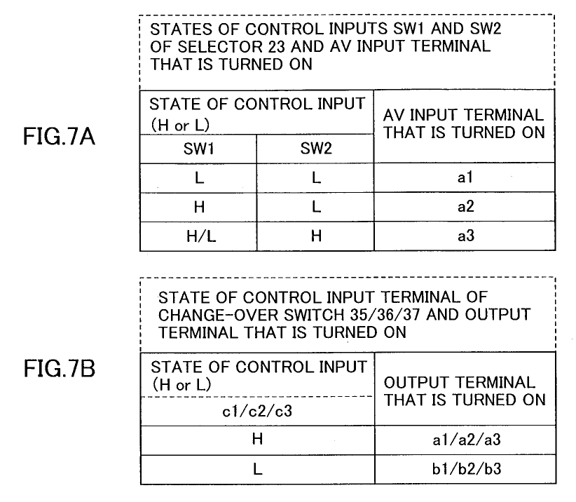

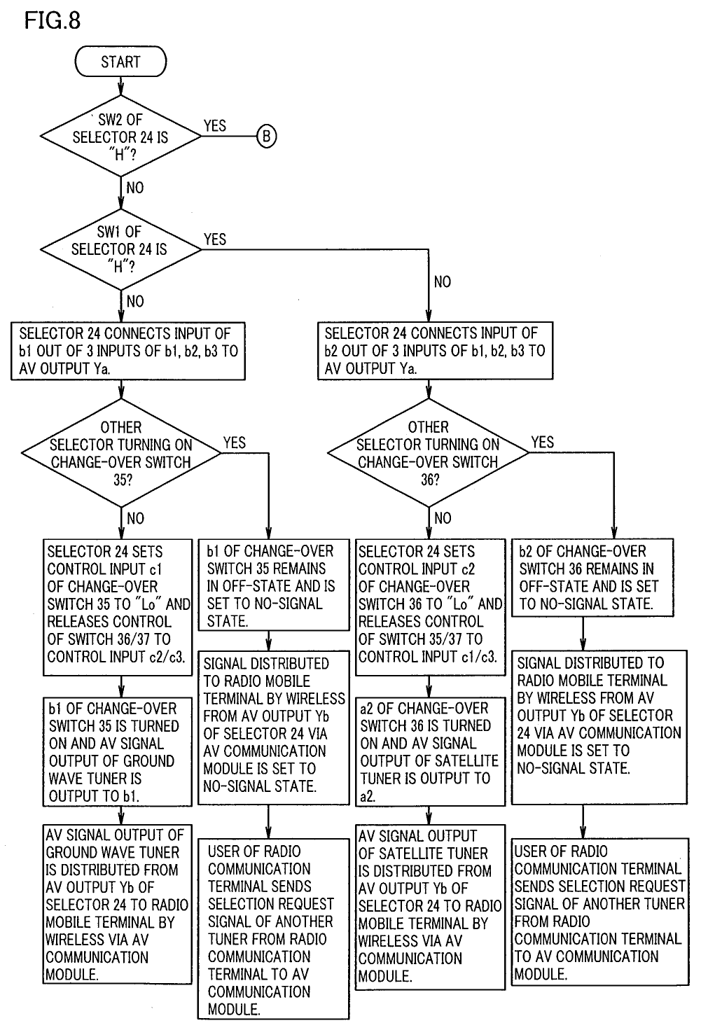

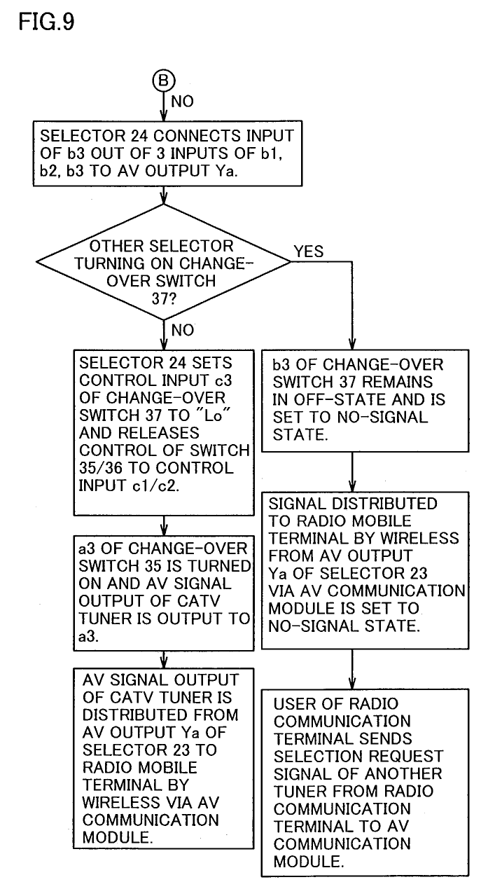

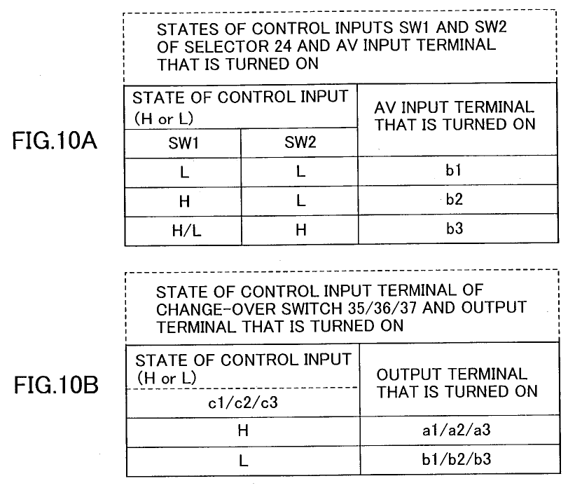

FIGS. 5 and 6 are flow charts for describing operations of selector 23 and change-over switch 35. FIGS. 7A and 7B show relations between a control terminal input of the change-over switch and a selected terminal. FIGS. 8 and 9 are flow charts for describing operations of selector 24 and change-over switch 36. FIGS. 10A and 10B show relations between a control terminal input of the change-over switch and a selected terminal.

A switching operation of selector 23 shown in FIG. 3 will now be described referring to FIG. 5 to FIGS. 7A and 7B. When SW2 terminal of selector 23 is determined as not being at the “H” level at a step SP1 (“step” is abbreviated as SP in the drawings) shown in FIG. 5, and when SW1 terminal of selector 23 is determined as not being at the “H” level at a step SP2, selector 23 connects an input of a1 out of three inputs of a1, a2, a3 to output Ya at a step SP3.

A determination is made as to whether the other selector 24 is turning on change-over switch 35 or not at a step SP4. If not, selector 23 sets control input c1 of change-over switch 35 to the “H” level and releases the control of switch 36/37 to control input c2/c3 at a step SP5. At a step SP6, a1 terminal of change-over switch 35 is turned on and an AV signal output of ground wave tuner 15 is output to a1 terminal. The AV signal of ground wave tuner 15 is distributed to a radio mobile terminal by wireless from AV output Ya of selector 23 via AV communication module 1.

If the other selector is turning on change-over switch 35 at step SP4, a1 terminal of change-over switch 35 is set to a no-signal state at a step SP8, and a signal distributed to the radio mobile terminal by wireless from AV output Ya of selector 23 via AV communication module 1 is set to the no-signal state at a step SP9. At a step SP10, a user of a radio communication terminal sends a selection request signal of another tuner from the radio communication terminal to the AV communication module.

If SW1 terminal of selector 23 is at the “H” level at the aforementioned step SP2, selector 23 connects an input of a2 out of three inputs of a1, a2, a3 to AV output Ya at a step SP11. Then, a determination is made as to whether the other selector is turning on change-over switch 36 or not at a step SP12. If not, selector 23 sets control input c2 of change-over switch 36 to the “H” level and releases the control of switch 35/37 to control input c1/c3 at a step SP13. At a step SP14, a2 of change-over switch 36 is turned on and an AV signal output of satellite tuner 17 is output to a2. The AV signal output of satellite tuner 17 is distributed to a radio mobile terminal by wireless from AV output Ya of selector 23 via AV communication module 1 at a step SP 15.

If the other selector is turning on change-over switch 36 at the aforementioned step SP12, a2 of change-over switch 36 remains in an off-state and is set to a no-signal state at a step SP16. A signal distributed to the radio mobile terminal by wireless from AV output Ya of selector 23 via AV communication module 1 is set to the no-signal state at a step SP17. At a step SP18, a user of a radio communication terminal sends a selection request signal of another tuner from the radio communication terminal to AV communication module 1.

If SW2 terminal of selector 23 is determined as being at the “H” level at the aforementioned step SP1, selector 23 connects an input of a3 out of three inputs of a1, a2, a3 to AV output Ya at a step SP19 shown in FIG. 6. A determination is made as to whether the other selector is turning on change-over switch 37 or not at a step SP20. If not, selector 23 sets control input c3 of change-over switch 37 to the “H” level and releases the control of switch 35/36 to control input c1/c2 at a step SP21. At a step SP22, a3 of change-over switch 35 is turned on and an AV signal output of CATV tuner 20 is output to a3. The AV signal output of CATV tuner 20 is distributed to a radio mobile terminal by wireless from AV output Ya of selector 23 via AV communication module 1 at a step SP 23.

If the other selector is turning on change-over switch 37 at the aforementioned step SP20, a3 of change-over switch 37 remains in an off-state and is set to a no-signal state at a step SP24. A signal distributed to the radio mobile terminal by wireless from AV output Ya of selector 23 via the AV communication module is set to the no-signal state at a step SP25. At a step SP26, a user of a radio communication terminal sends a selection request signal of another tuner from the radio communication terminal to AV communication module 1.

Selector 24 similarly operates as shown in FIG. 8 to FIGS. 10A and 10B. As only selector 23 in FIGS. 5-7A, 7B is replaced by selector 24 and AV communication module 1 is replaced by AV communication module 2 in FIGS. 8-10A, 10B, overlapping descriptions thereof will not be repeated.

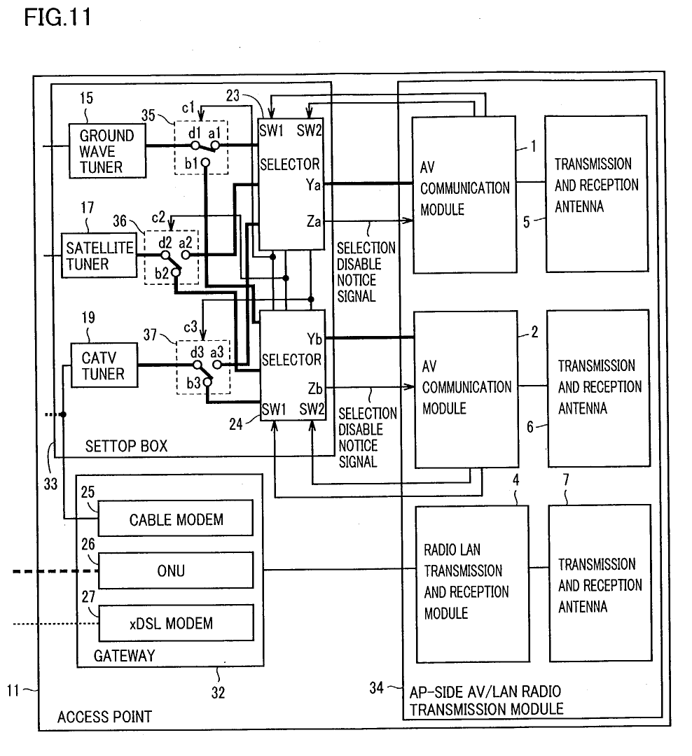

FIG. 11 is a block diagram of an access point according to a third embodiment of the present invention. In the embodiment shown in FIG. 11, when the tuner to be selected is already used by the other selector and the change-over switch cannot be turned, a tuner selection disable signal is sent from a Za terminal and a Zb terminal to AV communication modules 1, 2, and AV communication modules 1, 2 send this signal to a radio terminal which is in communication by wireless. Other structures are similar to that in FIG. 3. With this access point 11, the radio terminal can rapidly notice when the tuner to be selected is already used by another radio terminal and smoothly select another tuner.

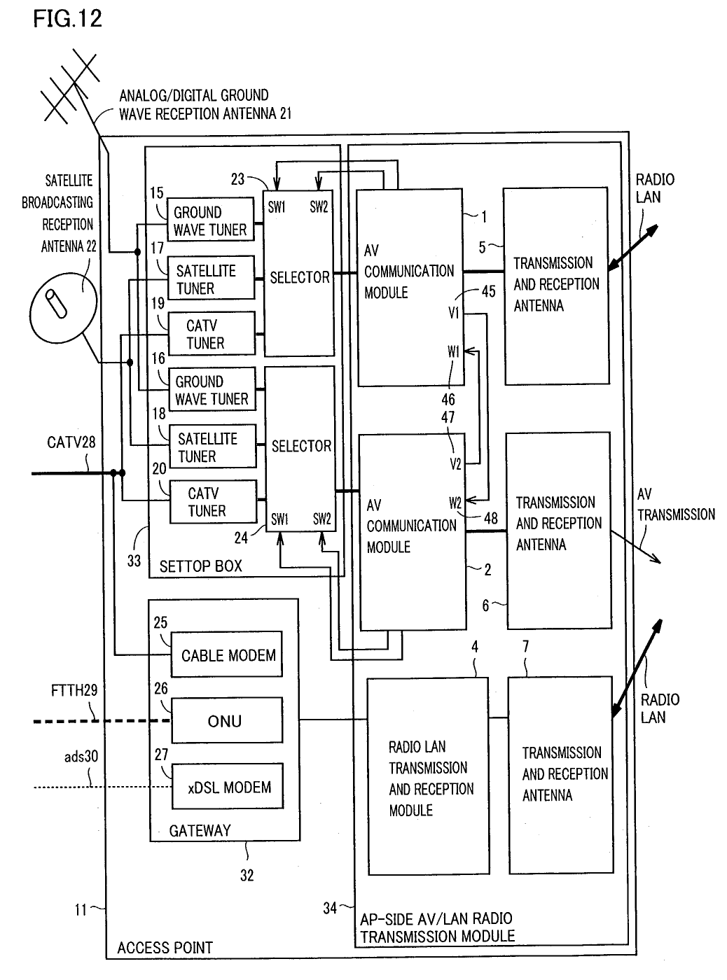

FIG. 12 is a block diagram of an access point according to a fourth embodiment of the present invention. In this embodiment, among a plurality of AV communication modules having priorities assigned thereto in access point 11, only an AV communication module having the highest priority of AV communication modules which are not connected with radio terminals originates a radio terminal sense signal. A situation will be described wherein AV communication module 1 is set to have a first priority and AV communication module 2 is set to have a second priority.

AV communication module 1 detects an output signal from an output terminal V2 of AV communication module 2, which is the other AV communication module, at input terminal W1 to detect whether the AV communication module is in communication with a communication terminal or not. When three or more AV communication modules are provided, similar connection and detection are performed to each of the other AV communication modules. At the same time, AV communication module 1 sends a signal noticing that it is not connected to a radio terminal from output terminal V1 to input terminal W2 of AV communication module 2. When three or more AV communication modules are provided, each of the other AV communication modules is similarly connected and a non-connection notice signal is sent. With this, the AV communication module can recognize connected/non-connected states of the other AV communication modules.

Then, AV communication module 1 recognizes that it has a first priority of non-connected AV communication modules, and sends a radio terminal sense signal. When notebook computer 12 as a radio terminal detects the signal and sends back a connection request signal to this AV communication module to start communication, a radio terminal connection signal is originated from an output terminal (V1) 45 of AV communication module 1. AV communication module 2 receives this signal at an input terminal (W2) 48 and recognizes that now it has the highest priority of non-connected AV communication modules, and starts to originate the radio terminal sense signal. PDA 14 as a radio terminal detects this signal and starts communication with the AV communication module. By making only one of non-connected AV communication modules originate the radio terminal sense signal, interference and power consumption can be reduced.

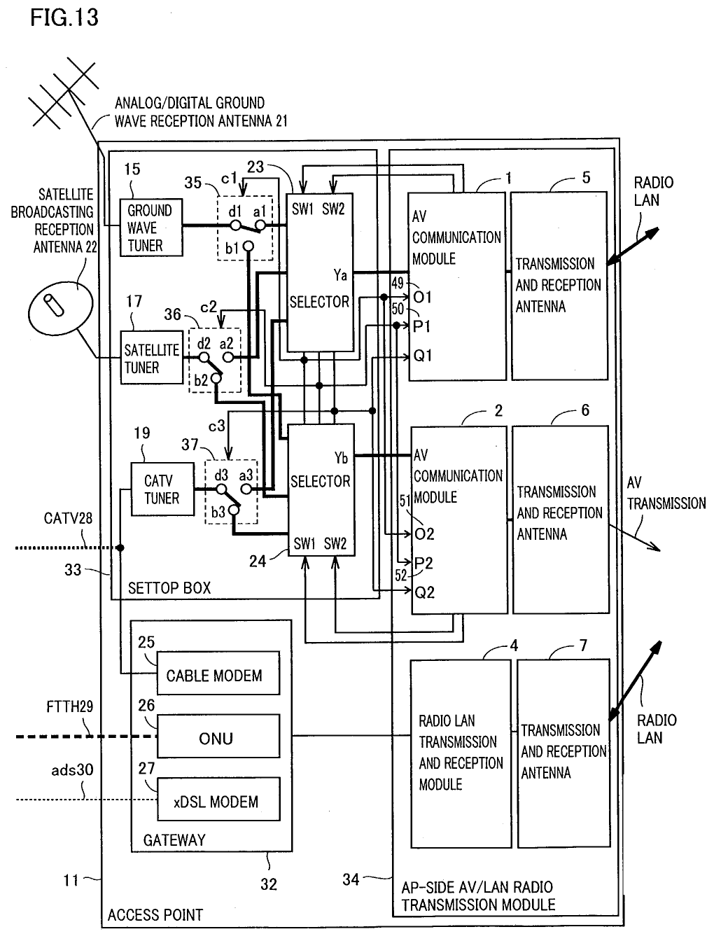

FIG. 13 is a block diagram of an access point according to a fifth embodiment of the present invention. In this embodiment, a terminal detecting a control bus signal of each change-over switch is provided in each AV communication module. More specifically, an O1 terminal, a P1 terminal and a Q1 terminal are provided in AV communication module 1, while an O2 terminal, a P2 terminal and a Q2 terminal are provided in AV communication module 2. With this, the tuner selected by the other AV communication module can be recognized, and this information can be sent to a radio terminal. The radio terminal receives this information and indicates the information on a display. The radio terminal can select a tuner which is not selected by seeing the indication of the information.

With this, by AV communication module 1 continuing a one-to-one connection with a radio terminal until no non-communicating AV communication module is left, a transmission system of resending when an error occurs as indicated in Japanese Patent Application No. 2000-312890 can be implemented.

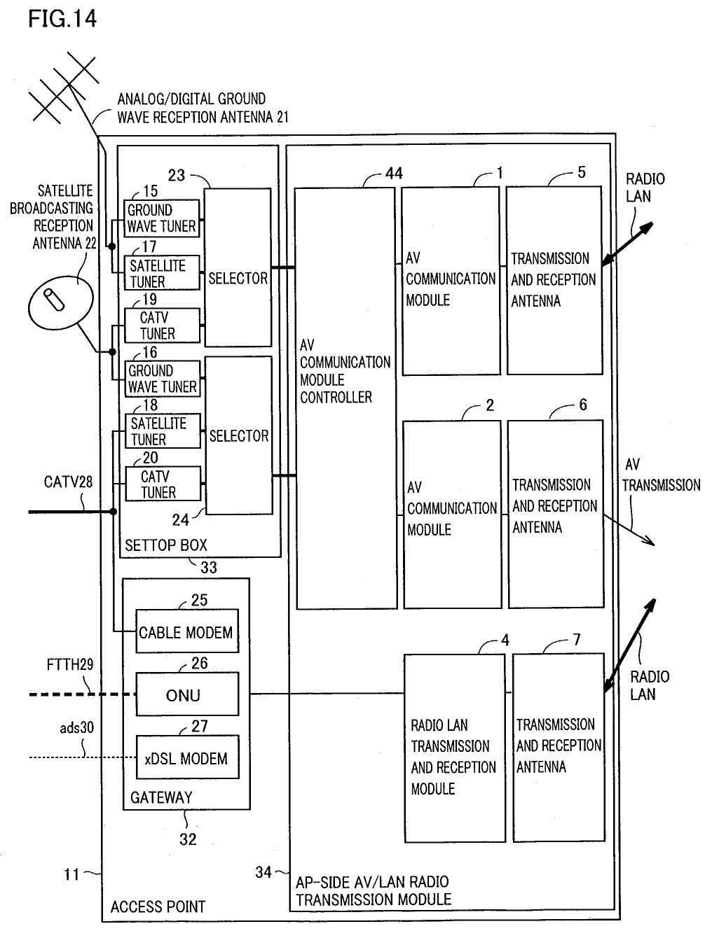

FIG. 14 is a block diagram of an access point according to a sixth embodiment of the present invention. This embodiment includes an AV communication module controller 44 which, when further radio terminal requests the AV signal distribution while no non-communicating AV communication module is left, compares a desired channel in the requested AV signal with the channels in the AV communication modules which are already in communication, and if there is the same channel, directs to the corresponding AV communication module to divide a bandwidth of an error resending and switch the one-to-one connection to a one-to-multiple connection, and thereby increases the number of radio communication terminals that can receive AV distribution.

It is to be noted that, a system administrator may be able to set the AV communication module which can always maintain the one-to-one connection.

It is also possible to reduce interference between AV signal transmissions by ensuring frequency bandwidths used by a plurality of AV communication modules in separate bandwidths within a 2.4 GHz band, and ensuring a transmission bandwidth of a radio LAN therebetween.

Further, the number of radio communication terminal devices which can receive AV distribution may be increased while suppressing the interference between AV signal transmissions by increasing the transmission bandwidth by adding a 5.2 MHz band to a 2.4 GHz band as a radio frequency bandwidth to be used.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An access point for local area radio communication with a plurality of radio information terminal devices, comprising:
a gateway unit enabling an internet connection in a plurality of different circuits;
a settop box unit having a tuner to receive broadcasting from each of a plurality of different media and a selector selecting and outputting a video signal and an audio signal from said tuner corresponding to a request signal; and
an AV/LAN radio transmission unit having a video and audio communication module to transmit a video signal and an audio signal output from said settop box unit by wireless and receive a request signal for changing a received broadcasting channel and broadcasting media, a transmission and reception module connected to pairs of communication antennas and said gateway unit and performing transmission and reception for local area radio communication, and a pair of transmission and reception antennas; wherein
said local area radio communication and communication for a plurality of said AV signal distributions and reception of a request signal for changing a received broadcasting channel and broadcasting media are respectively performed in frequency bands that are not overlapping one another.

2. The access point according to claim 1, wherein
when reception of AV signal distribution is requested from said radio information terminal device, a connection with the radio information terminal device is established according to priorities assigned to a plurality of said AV communication modules.

3. The access point according to claim 2, further comprising:
an output terminal provided corresponding to number of all other AV communication module and noticing that an AV signal is distributed to said radio information terminal device in said plurality of AV communication modules;
an input terminal receiving a signal noticing that an AV signal is distributed from all other AV communication module; and
means for connecting said input terminal and said output terminal, allowing only an AV communication module having the highest priority of AV communication modules not connected to said radio information terminal device to originate a radio signal sensing a radio information terminal device, and allowing the AV communication module originating the sense signal to start connection with a radio information terminal device and to concurrently send a signal noticing that it is connected to other AV communication module.

4. The access point according to claim 2, wherein
in a plurality of AV communication modules having said priorities allocated thereto, the lowest priority is allocated when distribution of an AV signal to said radio information terminal device is ended.

5. The access point according to claim 1, comprising:
all or a part of a cable modem, an optical network unit and an xDSL modem to enable said gateway unit to establish an internet connection in said plurality of different circuits; and
all or a part of an analog ground wave tuner, a digital ground wave tuner, a satellite broadcasting tuner, and a CATV tuner to enable reception of a plurality of different broadcasting media.

6. The access point according to claim 1, wherein
number of said tuners for each broadcasting media included is same as number of said AV communication modules, and
said selector selects a tuner corresponding to desired broadcasting media to be distributed among said plurality of tuners and connects with said AV communication module.

7. The access point according to claim 1, having
a change-over switch switching connections between an AV output portion of a tuner provided for each of said different broadcasting media and said plurality of selectors, wherein
each said selector operates said change-over switch relating to a certain tuner corresponding to a tuner selection request signal from said AV communication module when other selector is not operating, and enables switching of a change-over switch relating to other tuner from other selector.

8. The access point according to claim 7, wherein
when said selector cannot select a certain tuner corresponding to said tuner selection request signal because other tuner has already selected the tuner, said AV communication module detects a selection disable signal from the selector and notices to a radio information communication terminal device in communication that the tuner is used by other user and cannot be selected.

9. A radio communication system, comprising:
an access point according to claim 1; and
one or more mobile information terminal device including an AV communication module receiving an AV signal transmitted from said access point and transmitting a request signal for changing a received broadcasting channel and broadcasting media, a local area radio communication transmission and reception module transmitting and receiving local area radio communication data to and from said access point, switching means for selectively validating communication of one of the AV communication module and the local area radio communication transmission and reception module, and an AV/LAN radio transmission module having an antenna for transmission and reception transmitting a signal from a module validated by the switching means and receiving a radio signal; wherein
a local area radio communication service and a broadcasting contents distribution service provided from the access point can be switched and received corresponding to a request from said mobile information terminal device.

10. The radio communication system according to claim 9, wherein
each of the plurality of AV communication modules monitors all selection state of said change-over switch of each said tuner, sends information of selectable tuner or non-selectable tuner by wireless to a radio communication terminal receiving radio distribution of an AV signal, and indicates the information on a display of the radio terminal.

11. The radio communication system according to claim 9, wherein
when connection to said access point is attempted from said mobile radio terminal device after a determination is made whether to perform said local radio communication or to receive broadcasting contents distribution, said access point is connected with said radio LAN transmission and reception module when the local area radio communication is performed and is connected to an AV communication module that is not connected to other mobile information terminal among a plurality of AV communication modules when the broadcasting contents distribution is requested, the AV communication module is not connected to other mobile information terminal until a connection is ended by the connected mobile information terminal, and a selector keeps a connection of said tuner connected to the mobile information terminal device to prevent connection to other AV communication module until the mobile information terminal requests to change connected broadcasting media.

12. The radio communication system according to claim 9, wherein
a plurality of said AV communication modules in said access point successively originate signals noticing a non-communication state continuously or at regular intervals when not communicating with said mobile information terminal device, and
said mobile information terminal device finds a non-communicating module from the plurality of AV communication modules based on said signal noticing the non-communication state and starts communication, and the AV communication module in said access point concurrently stops originating the non-communication signal to prevent access from other mobile information terminal device.

13. The radio communication system according to claim 12, wherein
said plurality of AV communication modules in said access point successively originate signals noticing a non-communication state continuously or at regular intervals when not communicating with said mobile information terminal device, and
said mobile information terminal device finds a non-communicating module from the plurality of AV communication modules based on said signal noticing the non-communication state and starts communication, and the AV communication module in said access point concurrently stops originating the non-communication signal to prevent access from other mobile information terminal device until no non-communicating AV communication module is left in said access point, and said mobile information terminal device and said AV communication module maintain a one-to-one connection.

14. The radio communication system according to claim 12, wherein
a transmission system of resending when an error occurs is used as radio transmission of said AV signal, and transmission from an AV communication module already in communication in said access point is not received by said plurality of radio mobile information terminal devices even when the same video is requested, but other non-communicating module is allocated to keep high-quality AV signal transmission with less errors.

15. The radio communication system according to claim 12, comprising
an AV communication module controller that, when new one of said radio mobile information terminal device requests further AV signal distribution while no non-communicating said AV communication module is left, compares a desired channel in a requested AV signal with a channel in the AV communication module already in communication, and if there is the same channel, directs to the corresponding AV communication module to divide a bandwidth of an error resending and switch a one-to-one connection to a one-to-multiple connection, wherein
number of radio mobile information terminal devices that can receive broadcasting contents from said access point increases.

16. The radio communication system according to claim 15, wherein
a system administrator can previously set a part of said plurality of AV communication modules in said access point as an AV communication module maintaining a one-to-one connection state to provide broadcasting contents only to a specific person of users each receiving the broadcasting contents with said radio information terminal device.

17. The radio communication system according to claim 9, wherein
ensured bandwidths of said AV signal transmission are arranged in separate frequency bandwidths, and a transmission bandwidth of local area radio communication is allocated in a frequency bandwidth therebetween to reduce interference between said AV signals.

18. The radio communication system according to claim 9, wherein
a transmission bandwidth of radio to be used is further increased, and a bandwidth used for AV signal transmission is allocated so as to always have the largest bandwidth space.
